(19) United States
(12) Patent Application Publication
(10) Pub. No.: US 2022/0129857 A1
(43) Pub. Date: Apr. 28, 2022

(54) SYSTEMS AND METHODS FOR ANALYZING WORKER CONFORMANCE AND EFFICIENCY

(71) Applicant: NICE LTD., Ra'anana (IL)

(72) Inventors: Niranjan Nitin Bagade, Pune (IN); Tanmay Deepak Patwardhan, Pune (IN)

(73) Assignee: NICE LTD., Ra'anana (IL)

(21) Appl. No.: 17/081,346

(22) Filed: Oct. 27, 2020

(51) Int. Cl. G06Q 10/10; G06Q 10/06; H04M 3/51

(52) U.S. Cl. CPC G06Q 10/1091; G06Q 10/105; H04M 3/51; G06Q 10/06398

(57) ABSTRACT

A system and method may determine performance data for workers by for example generating or receiving, for a set (e.g. one or more) of workers, computer data describing total scheduled work time for the set of workers for a period or range of time; and obtaining or receiving for the set of workers computer data describing total out of conformance time for the set of workers for the period or range of time. The total scheduled work time for the set of workers for the period of time may have subtracting from it the total out of conformance time for the set of workers for the period of time, to create an intermediate sum. This intermediate sum may be divided by the total scheduled work time for set of workers for the period of time to calculate the non-productive conformance percentage for the set of workers.

### FIELD OF THE INVENTION

The present invention relates generally to analysis of data related to worker performance, in particular to a technological solution analyzing worker conformance and adherence.

### BACKGROUND OF THE INVENTION

Organizations such as call centers, or other businesses, may want to identify worker conformance and adherence. A worker's schedule may outline different times when a worker is supposed to be working, when a worker is not supposed to be working, and for the times the worker is supposed to be working, permitted non-productive time when the worker is not performing productive work, but is rather on break or lunch or similar activity, and is typically being paid. Conformance may measure the total time the worker is supposed to work, according to their schedule, compared with the total time the worker actually worked. Adherence on the other hand, measures how well the worker is aligned with their schedule. For example, if an employee is scheduled to work 60 minutes commencing at 9:00 AM, but the worker starts late and works from 9:15 to 10:15, adherence is 75% as they only worked 45 minutes of the scheduled 9:00 to 10:00. Since the employee worked one hour and the schedule called for one hour, conformance is 100%. Both adherence and conformance can be applied to productive work (e.g. doing the work the worker is paid to do) and non-productive but scheduled time, such as a lunch break or another break.

Existing technology systems do not have the capability to highlight non-productive conformance at an agent or management unit (MU, e.g. a group of workers) level. Absence of insight to this data may leads to financial losses. Current work force management (WFM) technology focuses on adherence percentage and not on conformance measurements. Such systems include deficiencies, for example, not providing details about the total excess time spent on non-productive work (such as lunch, or a work break) by an agent or a management unit for a specific duration.

Time spent on non-productive work may include time for which a worker is paid, but where the worker is allowed to not be productive, such as a lunch break. Excess time spent on non-productive work may include such time not occurring within time slots for such work per a worker's schedule, or occurring to an amount greater than that permitted by a schedule. Prior technology systems may not provide details about the total non-productive conformance percentage of an agent or a management unit for a specific duration, which may be the time that agents are being paid but not performing work (which is allowed per company policy), and are doing so not within the time range or time amount the agents' work schedule permits such non-productive work to be performed. Such systems may not facilitate ranking or grading of the management units and agents on the basis of their non-productive conformance performance.

### SUMMARY

A system and method may determine performance data for workers by for example generating or receiving, for a set (e.g. one or more) of workers, computer data describing total scheduled work time for the set of workers for a period or range of time; and obtaining or receiving for the set of workers computer data describing total out of conformance time for the set of workers for the period or range of time. The total scheduled work time for the set of workers for the period of time may have subtracted from it the total out of conformance time for the set of workers for the period of time, to create an intermediate sum. This intermediate sum may be divided by the total scheduled work time for set of workers for the period of time to calculate the non-productive conformance percentage for the set of workers. Non-productive conformance time may be the amount of time allocated or scheduled for non-productive work compared to the amount of time actually spent on non-productive work. Out of conformance time for a worker may include time when the worker is not acting according to the scheduled duration.

Embodiments of the invention may improve WFM technology by for example allowing contact center supervisors to identify underperforming agents and management units on the basis of their non-productive conformance, and allow automatically gathering agent data, e.g. via agent use of agent terminals, and turning this data into conformance and adherence data. Such improved technology performs functions not reproduceable by a person, as a large amount of manual effort would be required by a human to consolidate and process such information to create reports which could be utilized to identify non-conforming agents. For a large contact center with many employees, this may be a substantial effort. No current contact center management software provides a detailed conformance report as embodiments of the invention may do.

For example, a supervisor in a contact center may want to reduce overall operational costs or identify which management units or agents are performing efficiently and which ones are performing poorly with respect to conformance compliance over the past year. In order to achieve this, a manager would want to understand the total excess time spent on non-productive work such as lunch, break etc. Since workers such as agents may be paid on an hourly basis, any excess time spent on non-productive activities is a financial loss to the organization.

An example illustrates the need for such technology: consider the allocated non-productive time of an organization, per agents' schedules is 60 minutes per shift. If such an organization has 1,000 workers such as agents, and 200 of the agents are spending 62 minutes on non-productive work instead of the scheduled 60 minutes (two minutes of non-productive out of conformance time, or excess non-productive time, per each of the 200 agents), then 400 minutes are wasted per day. Further, customer service may be affected: non-conformance or non-adherence may result in customers being placed on hold or waiting in a queue for longer than otherwise. If 400 minutes*365 days are wasted per year, approximately 2,500 hours or 100 days a year are lost. Assuming the pay rate is 20 dollars per hour, the organization is losing approximately 50,000 dollars per year.

Current technology focuses mainly on the adherence percentage of individual agents and management unit as opposed to conformance, which results in some defects. For example, such prior system do not provide details about the total excess time spent on non-productive work (e.g. lunch, break) by an agent or a management unit for a specific duration; do not provide details about the total non-productive conformance percentage of an agent or a management unit for a specific duration; and do not facilitate the ranking or grading of the management units and agents on the basis of their non-productive conformance performance.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 depicts a computing system according to embodiments of the present invention.

FIG. 2 is a flowchart depicting a method according to embodiments of the present invention.

FIG. 3 depicts an example agent level report displayed to a user according to an embodiment of the present invention.

FIG. 4 depicts an example management unit level report displayed to a user according to an embodiment of the present invention.

FIG. 5 shows a high-level block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention include a technology platform improving prior WFM technology by allowing improved analysis of workforce data. An embodiment may receive, e.g. via software operated by or tracking workers, data describing workers' activities or status (e.g. working, not working, on break, etc.), and calculate based on this data, out of conformance time for the set of workers for a certain period of time, possibly by coordinating the received data with data describing workers schedules. A process may subtract from the total scheduled work time, the total out of conformance time and divide the result by the total scheduled work time to calculate the non-productive conformance percentage for the worker or workers being analyzed.

While embodiments of the invention may be applied to different organizations, one example embodiment may be used with two different entities common to call contact centers: agents, the people performing the work of engaging in communications with customers; and management units, organizations or groups of agents. Embodiments may help supervisors at contact centers obtain exact historic non-productive conformance data over a period of time. Based on this data, supervisors may identify underperforming as well as overperforming outstanding agents and management units. As a result of data presented by embodiments of the present invention, actions to improve efficiency and reduce costs may be taken. For example, a supervisor may have one-on-one discussions with underperforming agents to understand the reasons for non-compliance, or arrange for training for agents to help them improve efficiency. The outstanding or overperforming agents can be identified for bonuses as well as taking steps to retain them in the organization. Supervisors can conduct discussions with high performing management units to identify, for example, key points of success: when a management unit is identified as outstanding performer compared to peers, a supervisor can observe and identify any special methodologies or practices implemented by that management unit which led to its success. Training related to these can then be conducted for poorly performing management units.

Embodiments of the present invention may help operators of organizations such as call centers to, for example, identify underperforming agents from the contact center on the basis of non-productive work. Embodiments of the present invention may allow supervisors to obtain a holistic view of management units, and draw attention to underperforming management units. By improving agents or management units, contact centers or other organizations can reduce potential losses.

Productive work is typically work that benefits the employer, e.g. an agent speaking with a customer at a call center; non-productive work may include employee activities that are permitted but do not benefit the employee such as lunch or break. Excess time, or excess time spent on non-productive work (also termed non-productive out of conformance time, non-productive conformance time, non-productive excess conformance time), may be non-conformance time, which may occur when a worker is at work, but not doing productive work (e.g. speaking with customers) they are supposed to be doing. For example, excess time or non-productive out of conformance time may include when a worker is supposed to be performing productive work per a schedule but is at lunch, or when the worker is not acting according to the schedule or scheduled duration for the worker and is doing non-productive work. Excess time, or excess time spent on non-productive work may also occur when a worker is not at work, but is scheduled to be working. One illustrative example assumes that a lunch break (paid time at work, and non-productive work) is from 1:00 PM to 2:00 PM.
If the worker is at lunch exactly between 1:00 PM to 2:00 PM, he is in adherence as well as in conformance.
If the worker takes his lunch break past 2:00 PM to, e.g. 2:15 PM the worker is out of adherence as well as out of conformance.
If the worker started his lunch at 1:15 PM instead of 1:00 PM, and finished it at 2:15 PM instead of 2:00 PM, then the worker is out of adherence (since his schedule was 1:00 PM to 2:00 PM), but he is in conformance (since his allocated lunch duration is 1 hour which he is following).

Current data production technology for contact centers and other workplaces cannot provide the analysis provided by embodiments of the present invention, which thus provide improvements to such technology. Embodiments may allow for determination of excess (e.g. out of the time or schedule bounds of what is allowed) time spent by agents or management units on non-productive work such as paid lunch or paid break time. Embodiment may provide comparison results among different agents or management units, for example based on non-productive work percentage. Agents or management units may have calculated their own non-productive conformance percentage on the basis of which comparison can be made between them. It may be impractical for a human to perform the calculations and produce the output as described herein, as a workplace such as a contact center may include thousands, e.g. 50,000, of workers, and the data may be collected via computer processes and stored in disparate databases, as for example described herein. Further, such data is typically detected or collected by a computer process, e.g. ACD software.

Without technology provided by embodiments of the present invention, it might take a large amount of time to calculate data such as non-productive conformance data for relevant periods of time such as a month or a year. Depending on the contact center size, this time duration can increase exponentially. A manual or human performed effort performing operations, monitoring agents and collecting data that are instead performed by improved technology according to some embodiments of the present invention may be impossible for one person. Embodiments of the present invention allow for such improvements to be performed in an automated way.

In one use-case example, example Agent 1 is scheduled for (typically paid) lunch between 1:00 PM to 1:30:00. However, Agent 1 starts a work-related call (e.g. useful work) at 12:58 PM and finishes the call at 1:05 PM. Per example work rules, his actual lunch break is now from 1:05 PM to 1:35 PM. Thus Agent 1 was out of adherence for 5 minutes due to his eating lunch during the 1:00-1:05 period, as per his lunch schedule which will affect the agent's overall adherence percentage. However, from a conformance perspective the agent worked with 100% conformance, taking his scheduled lunch time of 30 minutes; no excess out of conformance time exists. Current technologies do not provide insight into this. Similar examples exist with break time—e.g. a worker may be entitled to two (typically paid) breaks of 15 minutes per shift.

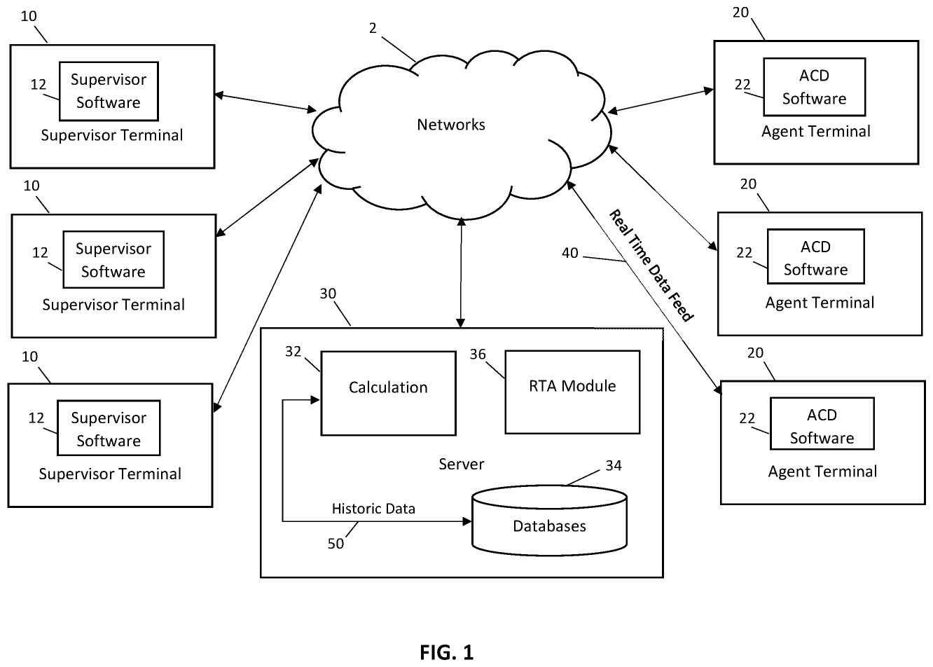

FIG. 1 depicts a computing system according to embodiments of the present invention. One or more supervisor terminals or workstations 10 and agent terminals 20 may communicate via networks 2 with a server 30 (one or more servers may be used). Server 30 may execute WFM software such as calculation module 32 (e.g. an agent/management unit conformance performance calculator) and maintain databases 34. Supervisor terminals or workstation 10 may execute supervisor software 12 which may accept input and provide output such as reports and displays as described herein. Each agent terminal 20 may operate software such as automatic call distributor (ACD) software 22 enabling, for example, communications with customers (e.g. making calls, placing customers on hold, etc.), access to and data entry in various databases relevant to customers, input from and output to agents. While ACD software 22 is shown at each agent terminal, a portion of ACD software 22 or its functionality may be at or performed at a central location, e.g. server 30, in order to answer and distribute calls and perform other centralized functionality. In some embodiments, data may be divided by customers of an entity operating server 30, and multiple customers may operate sets of supervisor workstations and agent terminals, and server 30 may divide the data appropriately and provide agent analysis to each agent.

ACD software 22 may track, or determine based on agent activity or input, an agent state: e.g. on a call with a customer, on break, at lunch, not working or logged in, etc. This may be done by having an agent enter data or enter a state (e.g. on break), or automatically in response to an agent action, e.g. an agent logging on may cause ACD software 22 to log a certain state, and an agent starting a call with a customer may cause ACD software 22 to log a certain state. ACD software 22 may send data such as agent states to software such as calculation module 32. ACD software 22 may track and communicate states as events. For example, if an agent is logged in on start of his/her shift, ACD software 22 may generate a “Login” event. If an agent receives a call, ACD software 22 may generate an “On Call” event. If an agent goes on break, then ACD software 22 may generate “Break” event. Such events, including but not limited to “break”, “On Call”, “Available” “on Hold”, may be transmitted from ACD software 22 to a real time adherence (RTA) module 36. Events may be communicated to modules such as databases 34 and calculation module 32. In some embodiments, agent events or data are stored in a customer's database, and this raw data feed is sent to a processor on a fixed interval time, e.g. every 15 or 30 minutes.

Data from ACD software 22 or agent terminals 20 may form a real time data feed 40 (shown for one agent terminal only), providing current or very recent data on agent work activity and the categories of activity agents are engaging in (e.g. productive, non-productive, not working, etc.), e.g. for the past 15-30 minutes. Real time data feed 40 may placed in databases 34, which may then provide a historic data feed 50 (e.g. providing agent state and other information older than 15-30 minutes). The various modules shown in FIG. 1 may form a workforce management (WFM) system. RTA module 36 and real time data feed 40 may process live events such as “break”, “on call”, “on hold”, “calling”, “lunch” etc. and display those to a requestor.

Historic events are typically provided to a WFM every 15 or 30 minutes, or in other time frames, depending on the configuration. ACD software 22 may send real-time events directly to other WFM modules as and when they occur. Real time events may give information about real-time or very recent activities. Historic information may tell WFM software about what other important activities happened with agents and other entities such as queues (e.g. queues at a contact center, holding customers calling into the contact center). By processing historic data, a WFM system may generate forecasts and schedules for the contact center.

An RTA module 36, e.g. executed by server 30, may receive agent events, e.g. from ACD software 22, and allow for the display of those events on a screen of, e.g., supervisor terminals or workstation 10, in real time, to allow a supervisor to know what an agent is doing at the present time.

Databases 34 may as a whole form a WFM database and may include, tables, including for example:
R_MU: management unit information, describing the makeup of management units;
R_EG: enterprise group (EG) information, used for management unit conformance reports. An enterprise group may be a larger unit containing multiple management units;
R_MUROSTER: details of management units and which agents are assigned to Mus including active agents within each MU;
R_AGTDATA: agent data;
R_AGTSYSSTATS: historic report data, including information about an agent's activity older than, for example 15 or 30 minutes;
R_AGTSCHED: agent schedule information;
R_MUSTATS: data describing calls such as total call hold time, ready time, work time etc. and historic data;
R_EXCP: agent activity mappings which may help a WFM in maintaining an agent's activities throughout the day.

The WFM system of FIG. 1 may receive real-time agent activities as well as historic agent activities, and store these details in WFM databases under various tables (e.g. in a database 34). Based on supervisor input, the WFM system may create and maintain schedules and forecasts for agents. Historic data may be transmitted from databases 34 to calculation module 32 typically at fixed intervals of for example 15 or 30 minutes.

In one embodiment, a supervisor, operating a supervisor terminal or workstation 10, e.g. via supervisor software 12, may input for example, a selection of a management unit, or another description of or select a set of workers e.g. a desired worker, agent, management unit, or other set of workers for examination), and other selection data such as a time period or time duration (e.g. the past week, the past month, or a certain year, a date range, etc.). While in the examples provided herein a management unit is described as a logical partition of a contact center, depending on the of type of organization, business, groups named other than management unit may be used. The supervisor can request that calculation module 32 or other system to perform calculations as described herein for the one or more workers selected. When a worker such as a supervisor selects a management unit or other group, this unit may contain many agents, and the supervisor can perform many activities using supervisor's software. The supervisor may login to a terminal and select for example an agent conformance performance section or module, and select a particular management unit to have a close look at conformance performance of agents belonging to that unit.

Calculation module 32 may receive data input by the supervisor, and receive or pull the relevant data, e.g. describing the selected workers or management unit, from the relevant databases, e.g. databases 34, and may calculate performance data for the workers, such as non-productive conformance percentage for the set of workers. If more than one worker is in a set, e.g. the set is a management unit, a process may sum the relevant amounts, e.g. scheduled work time or out of conformance time, across all workers in the set. For example, a calculation module 32 or other unit may receive for the set of workers, total scheduled work time, and total out of conformance time, for the selected period of time. In some embodiments, each discrete period of out of conformance time may be computed or accessed, and these various discrete amounts may be aggregated or added together to form a total for each worker. Calculation module 32 may subtract the total out of conformance time from the total scheduled work time and divide the resulting intermediate sum by the total scheduled work time, and possibly multiply by 100: the result may be termed the non-productive conformance percentage for the set of workers.

An example formula for calculating a non-conformance percentage for an individual worker or agent is:

((Sum of total scheduled work time for the agent)−(Sum of total non-performing out of conformance time for the agent))/(Sum of total scheduled work time for the agent)*100

An example formula for calculating non-conformance percentage for a group of agents or workers is:

((Sum of total scheduled work time for each agent in a set or MU)−(Sum total non-performing out of conformance time for each agent in the set or MU))/(Sum of Total scheduled work time for each agent in the a set or MU)*100

The normalization of multiplying by 100 need not be applied.

Total scheduled work time for a worker or agent may be a sum of all the durations of periods the agent is scheduled to work, typically for a certain time period. Total out of conformance time for a worker or agent, also called the sum of out of conformance time spent on non-productive work, may be a sum or aggregate of all out of conformance time (e.g. a sum of all different time durations for the different out of conformance events or periods) for that agent, typically for a certain time period—typically the same period as applied to scheduled work time. These calculations may be performed for a certain time period, e.g. a single day, or a range of days or other period of time; a summing or calculation may need to be done if the out of conformance time is not provided as a database value. The total excess non-productive conformance time may be for example the sum of out of conformance time spent on non-productive work for an agent, summed over the relevant or requested time period. This calculation may be performed for a management unit or other group of agents: for example for the requested time period the calculation may be performed for each agent in a management unit, and the results for each agent may be summed to produce the total for the management unit.

Other calculations may be performed: for example, total excess time spent on non-productive work for an agent or group of agents (e.g. management unit) for a period of time may be summed and displayed, or agents or management units may be graded, sorted or ranked based on calculated non-productive conformance percentage. For example, a single agent, or a group of agents or management units with the highest conformance percentage, or performance percentage above a threshold, may be graded A or rank 1, those having conformance percentage just below this group grade B, etc. The results, e.g. non-productive conformance percentage for a worker or a set of workers, may be displayed (e.g. on a supervisor terminal or workstation 10) or provided as a report, and the results may be acted on as described elsewhere herein.

A process may sum or aggregate all out of conformance time (e.g. a sum of all different time durations for the different out of conformance events or periods) for a set of agents, an agent, or a group of agents. For example, the schedule for a worker or agent for a particular time period such as a week or month may be set by a supervisor, and the agent is expected to follow this schedule. In one example, for a week of 5 working days, an agent is provided a nonproductive paid break of daily one hour each day: over the week his scheduled nonproductive break is 5 hours. If the agent is out of conformance for 5 minutes daily for this activity, then his total out of conformance time in a week is 25 minutes.

The agent's schedule time and his out of conformance time for a single day may be available from the relevant database. Embodiments may, for a period of time entered by a user such as one week one month or one year apply an algorithm and formula to aggregate these times and produce a total out of conformance time. Such an amount may be used in other calculations, and/or displayed to a user as a useful output in and of itself. The calculations and display of information may be done per individual agent or worker, to display out of conformance data for a specific agent, or may be done for groups of workers, e.g. a management unit or other group of workers. For example, a set of workers for which calculations are performed and results displayed may include one worker, or a number of workers, e.g. all workers who are members of a management unit. If more than one worker is analyzed, the total scheduled work time for the set of workers for the relevant period of time may be the sum, across all workers in the set (e.g. all members of the unit), of the total scheduled work time for each of the workers; and the total out of conformance time for the set of workers may be the sum of the total out of conformance time of each of the workers (e.g. all members of the unit).

A supervisor or other person may log in to supervisor terminal or workstation 10 and access supervisor software 12 (e.g. a webstation or graphical user interface), for example in communication with calculation module 32 and/or server 30 and access or have displayed agent conformance data.

Agent or worker work data may be gathered in different suitable manners, and calculations may be performed on agent work data to create out of conformance time data. For example, ACD software 22 executed by agent terminal 20 operated by a particular agent may accept input from an agent allowing ACD software 22 to determine if the agent is working on a productive task, is performing non-productive time (e.g. a meal, a break, etc.), not working, or performing another activity. An agent may provide explicit input to ACD software 22 corresponding to or providing a notification of the agent state (e.g. on break, at lunch, working on customer calls, etc.). Such agent input may be implicit: e.g. ACD software 22 may detect that an agent is participating in a customer call, and determine the state to be on a call or working. For each agent the recorded time allotted to certain activities, or transition, may be used with the expected schedule for that agent, to determine (e.g. via calculation module 32) out of conformance time for the agent or other data. Such data may be stored in a database, for example in table R_EXCP.

In one embodiment, a supervisor in a contact center may create a schedule describing the work hours of agents in a group. This scheduled work data may be sent to WFM systems described herein and may be stored in database(s). Periodically, e.g. at the end of every day, ACD software 22 may generate reports of the actual work done by agents in the relevant group of unit. Such reports may include start time and end time of each activity performed by an agent during the day, and may be sent to WFM modules and databases. WFM modules (e.g. calculation module 32) may have scheduled work details of agents as well as the actual work details performed by the agents during the day and may, from this, calculate conformance time for each agent for each activity using, for example, a formula such as:

Out of conformance time=actual event duration−scheduled event duration

Example values (e.g. stored in database 34 for such a calculation may include):

Scheduled break duration=60 min

Actual break duration=75 min

Out of conformance time=75 min−60 min=15 min.

Calculation module 32 may use data such as agent state and schedule information to determine conformance and other data such as adherence. For example, when an agent is working (e.g. on a call with a customer) calculation module 32 may determine the agent is in conformance. When an agent is not working or not at productive work (e.g. not logged in; or on break or lunch) during a period of time the agent is scheduled to be working calculation module 32 may determine the agent not in conformance; when an agent is working (e.g. logged in or state is working or on a call with customer) during a period of time the agent is scheduled to be working calculation module 32 may determine the agent is in conformance: the amount of time measured in conformance/not in conformance may be summed or aggregated, but also individual instances, e.g. individual amounts in Table 1 below, may be saved separately.

In one example of specific data, an agent is allowed to go on lunch between 1 PM to 2 PM. Due to an ongoing work call, the agent had to go on a lunch break at 1:05 PM instead of 1:00 PM. Table 1 below shows adherence and conformance calculations:

TABLE 1

| | Lunch Time | Lunch | Adherence | Conformance |
|---|---|---|---|---|
| # | From | Time To | status | status |
| 1 | 1:05 PM | 2:05 PM | Out of Adherence | In Conformance |
| | | | For 5 minutes | |
| 2 | 1:05 PM | 2:15 PM | Out of adherence | Out of conformance |
| | | | for 15 minutes | for 10 minutes |

In entry 1 in Table 1, the agent is out of adherence for 5 minutes as the agent was supposed to come back from lunch at 2:00 PM, but he came back at 2:05. But the same agent is in conformance as he took a one-hour break as per his scheduled duration. In entry 2 the agent is out of adherence for 15 minutes as the agent was supposed to come back from break at 2:00 PM. But he came back at 2:15 PM. But the same agent is out of conformance for 10 minutes as he took extra 10 minutes to come back from lunch. The amount of time the agent is supposed to have worked a shift, per the agent schedule, may be summed and the amount of time the agent actually worked (productive and also non-productive) may be subtracted from that to calculate adherence.

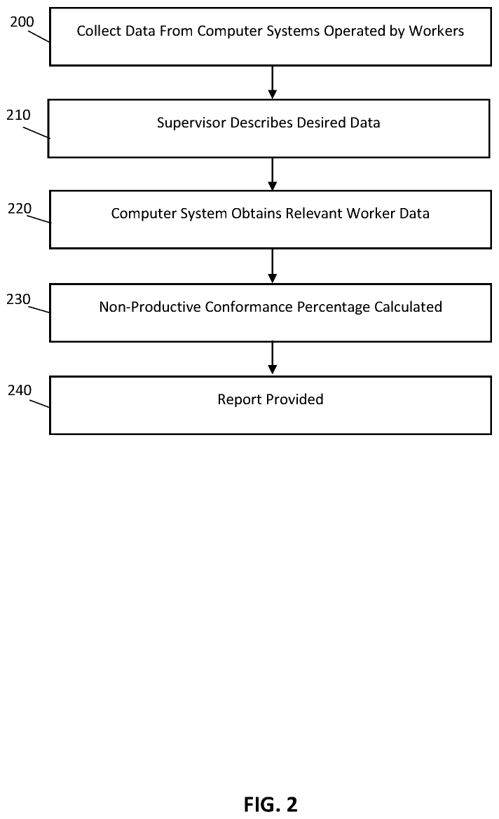

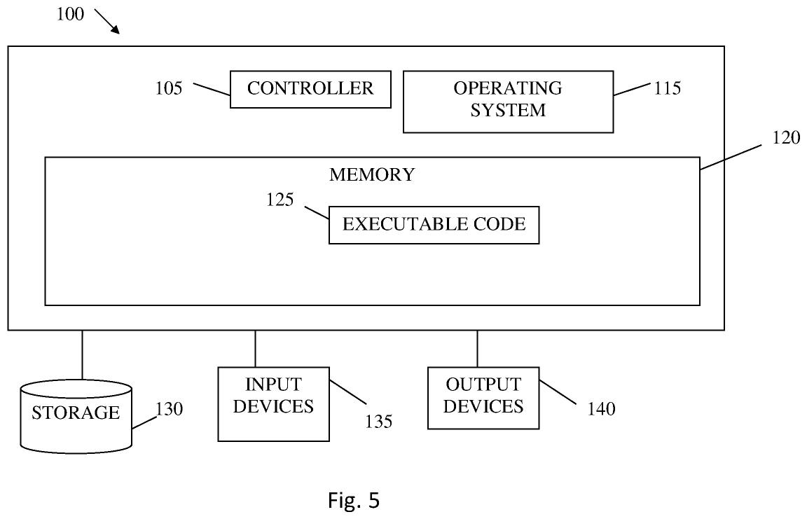

FIG. 2 is a flowchart depicting a method according to embodiments of the present invention. The operations of FIG. 2 may be performed with the systems as shown in FIGS. 1 and 5, but may be performed using other systems.

In operation 200 data may be collected from computer systems operated by agents or other workers describing the work state of the agent, e.g. working, not working, on a call, on a break, at lunch, etc. The data may be produced by agents or other workers working with agent terminals. For example, via agent software executed by a terminal operated by an agent, information (represented by computer data) may be gathered describing the agent's states or activities. Periodically, or upon a user request, a process may calculate, based on the information describing an agent's activities, out of conformance time for the agent.

ACD software 22 may in the context of a call center answer incoming calls and route them to a specific agent or department within a company. ACD 22 may function with Computer Telephony Integration (CTI) systems and Interactive Voice Response (IVR) to intelligently route incoming calls to the most appropriate agent. ACD software 22 may acquire usage data such as for example: the number of incoming calls, amount of time an agent spends on the phone with a caller, total number of calls (incoming and outgoing), length of calls, waiting time before the call was answered, etc. ACD software 22 may have the capability to send the current activity being performed by all agents to a consuming such as RTA module 36 or other WFM modules. ACD software 22 may send a periodic (e.g. daily) report of all activities being performed during the day by all agents to RTA module 36 or other WFM modules. When this data is received by RTA module 36 it may calculate the out of conformance time for agents using the scheduled activity data present in the WFM system and the actual activity data passed to it from ACD software 22. A system (e.g. ACD software) may track for each agent activity (e.g. classified into categories such as open, lunch, break, sick-paid, sick-unpaid, tardy, working, on-call, etc.) with time periods (e.g. start and end) for each activity, and whether the activity is paid nonproductive activity or unpaid nonproductive. An “open” state may indicate the worker is working e.g. in the worksite or office, but is not actually doing any work through no fault of the worker, e.g. not attending to any customer call or doing other work, rather available to receive the next task or customer call, but sitting idle as there are no tasks to be provided. For example, break, lunch and sick—paid are paid nonproductive activities, whereas open is paid productive activity, and forced day off is non-paid nonproductive activity. Other embodiments or organizations may define their own set of paid and non-paid activities with their corresponding productive nonproductive values. Each of the states may be categorized as or associated with a value for example non-productive work, productive work, or another category such as not working. For example a paid-productive category may be associated with a state such as call activity, on hold, connecting to customer, etc. A paid-nonproductive category may be associated with states such as meeting, break, lunch, etc. Organizations may use different states and values or categories.

The relevant data may be received by the WFM system, e.g. a system such as shown in FIG. 1.

In operation 210, a supervisor or other person desiring conformance or other data may enter specifications describing desired data: for example a specific single worker, a management unit with a number of workers, or a set of workers (e.g. one or more), may be selected or named; and a time period or duration may be selected or input. This user input may be received by the WFM system.

In operation 220 a computer system, such as the WFM system, may obtain or request the relevant worker or agent data. For example, a WFM system may receive for the set of one or more workers specified (or the group such as the MU specified) in operation 210, computer data describing the total scheduled work time, e.g. as a group of the selected workers, or for each of the set of workers for the selected duration or period of time; and also and the total out of conformance time for the set of workers for the period of time (which may be the sum of the total out of conformance time of each of the plurality of members). If the supervisor specified a group or MU, the total scheduled work time for the set of workers for the period of time may be the sum of the total scheduled work time for each of the plurality of members.

Each of the total scheduled work time and total out of conformance time may be amounts of time, e.g. numbers of minutes, hours and minutes, etc. A supervisor in an organization may create a schedule describing the work hours of agents in a group and this scheduled work data may be sent to WFM modules, e.g., calculation module 32 to store in database 34. At the end of each period, e.g. every day, ACD software 22 may generate a report of the actual work done by agents in the unit, and send this information to calculation module 32 to store in database 34. Calculation module 32 having received both the scheduled work details of agents as well as the actual work details performed by the agents may apply the formulas and calculations provided herein to calculate the values of non-conformance percentage, out of Conformance time and ranking or grading of agents.

Agent states or agent activity for a period of time may be analyzed and compared to that agent's schedule to calculate out of conformance time for the agent. In some embodiments, based on worker activity for a set of workers using software operated by the workers, and on the schedules for the set of workers, a process may calculate data describing out of conformance time for the set of workers.

In operation 230 the non-productive conformance percentage for the set of workers for the period of time may be calculated. For example, a process may subtract from the total scheduled work time for the set of workers for the period of time, the total out of conformance time for the set of workers for the period of time, to create an intermediate sum. The intermediate sum may be divided by the total scheduled work time for set of workers for the period of time, and in some embodiments this may be multiplied by 100, to calculate the non-productive conformance percentage.

In operation 240 a report or screen display may be provided to a supervisor, e.g. via a supervisor terminal or workstation. For example, the non-productive conformance percentage for the set of workers may be displayed.

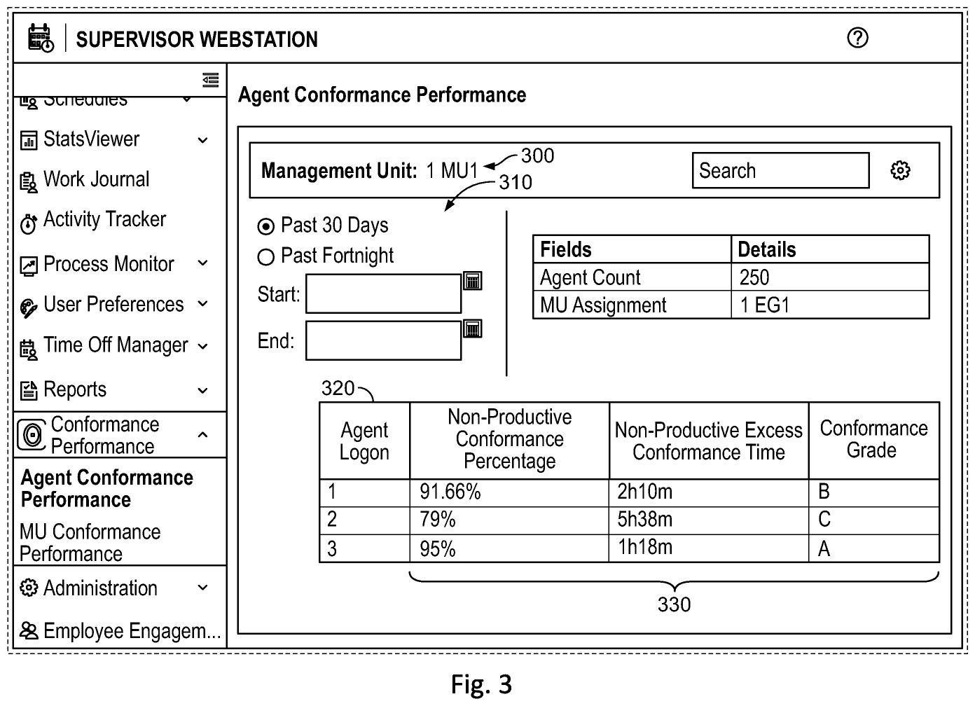

FIG. 3 depicts an example agent level report displayed to a user according to an embodiment of the present invention. A user or supervisor may select a management unit (e.g. field 300) containing the specific agent whose data is required and the duration or time period for which the data is required (e.g. field 310). The supervisor may have displayed a list of agents (e.g. field 320) in the management unit with details (e.g. field 330) such as:
Non-Productive Conformance Percentage
Excess time spent on Non-productive work (e.g. total or summed non-productive work time)
Conformance grade on the basis of non-productive percentage

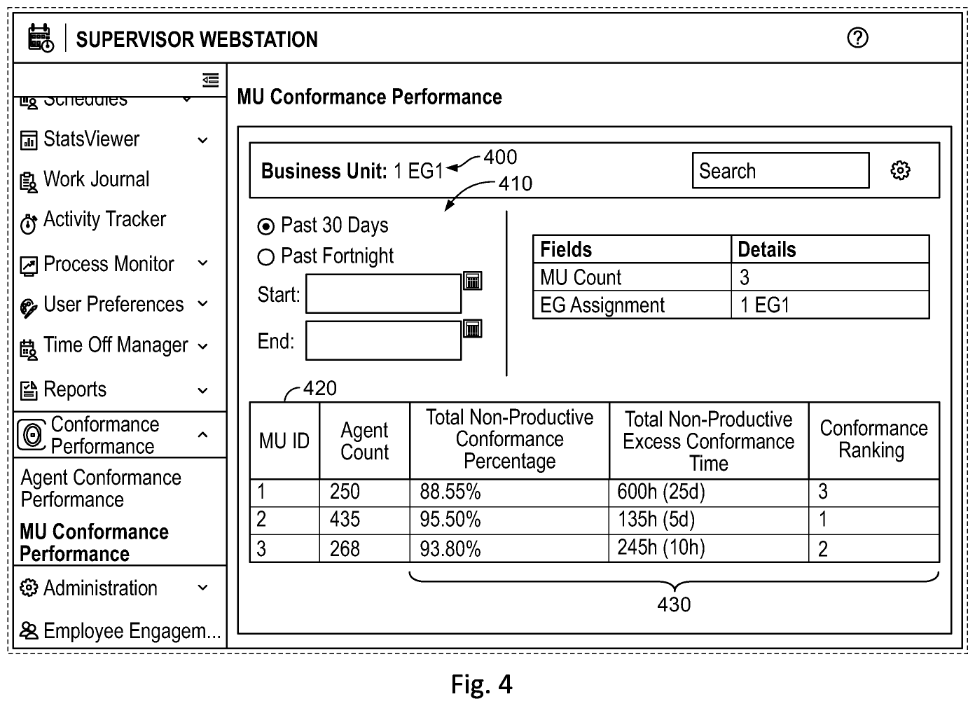

FIG. 4 depicts an example management unit level report displayed to a user according to an embodiment of the present invention. A Supervisor may select an enterprise group (e.g. field 400) whose management unit data is required. A user or supervisor may select a period or duration (e.g. field 410) for which data is required. The supervisor may have displayed a list of management units (e.g. field 420) in an enterprise group (e.g. a larger group including management units) with details (e.g. field 430) such as:
Agent count for the management unit
Non-productive conformance percentage for the management unit
Excess time spent on non-productive work for the management unit (e.g. total or summed non-productive work time)
Conformance grade for the management unit on the basis of the respective non-productive percentage.

FIG. 5 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment such as terminals 10 and 20, server 30, and other modules discussed herein may be or include, or may be executed by, a computing device such as included in FIG. 5, although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data such as agent states, conformance data, etc.

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 2, or acting as modules or devices of FIG. 1, according to embodiments of the present invention. In some embodiments, more than one computing device 100 or components of device 100 may be used for multiple functions described herein. For the various modules and functions described herein one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as worker state data or output data may be stored in a storage 130 and may be loaded from storage 130 into a memory 120 where it may be processed by controller 105. In some embodiments, some of the components shown in FIG. 5 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention may be embodied in other specific forms without departing from the spirit or essential characteristics thereof. The embodiments described are therefore to be considered in all respects illustrative rather than limiting of the invention described herein. Scope of the invention is thus indicated by the appended claims, rather than by the description, and all changes that come within the meaning and range of equivalency of the claims are therefore intended to be embraced therein.

In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for determining performance data for workers, comprising:
receiving for a set of workers computer data describing total scheduled work time for the set of workers for a period of time;
receiving for the set of workers computer data describing total out of conformance time for the set of workers for the period of time; and
subtracting from the total scheduled work time for the set of workers for the period of time, the total out of conformance time for the set of workers for the period of time, to create an intermediate sum, and dividing the intermediate sum by the total scheduled work time for set of workers for the period of time to calculate the non-productive conformance percentage for the set of workers.

2. The method of claim 1 wherein the set of workers consists of one worker.

3. The method of claim 1 wherein:
the set of workers comprises a plurality of members of a management unit;
the total scheduled work time for the set of workers for the period of time is the sum of the total scheduled work time for each of the plurality of members; and
the total out of conformance time for the set of workers for the period of time is the sum of the total out of conformance time of each of the plurality of members.

4. The method of claim 1 comprising displaying the non-productive conformance percentage for the set of workers.

5. The method of claim 1 comprising gathering, via agent software executed by a terminal operated by an agent, information describing the agent's activities, and calculating, based on the information describing the agent's activities, out of conformance time for the agent.

6. The method of claim 1 comprising determining, via agent software executed by a terminal operated by an agent, an agent state, and calculating, based on the agent state and an agent schedule, out of conformance time for the agent.

7. The method of claim 1 wherein out of conformance time for a worker comprises time when the worker is not acting according to the scheduled duration for the worker.

8. A system for determining performance data for workers, comprising:
a memory; and
a processor configured to:
receive for a set of workers computer data describing total scheduled work time for the set of workers for a period of time;
receive for the set of workers computer data describing total out of conformance time for the set of workers for the period of time; and
subtract from the total scheduled work time for the set of workers for the period of time, the total out of conformance time for the set of workers for the period of time, to create an intermediate sum, and dividing the intermediate sum by the total scheduled work time for set of workers for the period of time to calculate the non-productive conformance percentage for the set of workers.

9. The system of claim 8 wherein the set of workers consists of one worker.

10. The system of claim 8 wherein:
the set of workers comprises a plurality of members of a management unit;
the total scheduled work time for the set of workers for the period of time is the sum of the total scheduled work time for each of the plurality of members; and
the total out of conformance time for the set of workers for the period of time is the sum of the total out of conformance time of each of the plurality of members.

11. The system of claim 8 wherein the processor is configured to display the non-productive conformance percentage for the set of workers.

12. The system of claim 8 wherein the processor is configured to gather, via agent software executed by a terminal operated by an agent, information describing the agent's activities, and calculate, based on the information describing the agent's activities, out of conformance time for the agent.

13. The system of claim 8 wherein the processor is configured to determine, via agent software executed by a terminal operated by an agent, an agent state, and calculating, based on the agent state and an agent schedule, out of conformance time for the agent.

14. The system of claim 8 wherein out of conformance time for a worker comprises time when the worker is not acting according to the scheduled duration for the worker.

15. A method for analyzing worker data, comprising:
based on worker activity for a set of workers using software operated by the workers, and on the schedules for the set of workers, calculating computer data describing out of conformance time for the set of workers;
receiving for the set of workers computer data describing scheduled work time for the set of workers for a period of time; and
subtracting from the scheduled work time for the set of workers, the out of conformance time for the set of workers, to create an intermediate sum, and dividing the intermediate sum by the scheduled work time for set of workers to calculate the non-productive conformance percentage for the set of workers.

16. The method of claim 15 wherein the set of workers consists of one worker.

17. The method of claim 15 wherein:
the set of workers comprises a plurality of members of a management unit;
the scheduled work time for the set of workers is the sum of the scheduled work time for each of the plurality of members; and
the out of conformance time for the set of workers is the sum of the out of conformance time of each of the plurality of members.

18. The method of claim 15 comprising displaying the non-productive conformance percentage for the set of workers.

19. The method of claim 15 wherein out of conformance time for a worker comprises time when the worker is not acting according to the scheduled duration for the worker.
